(19) United States
(12) Patent Application Publication
(10) Pub. No.: US 2026/0220377 A1
(43) Pub. Date: Jul. 30, 2026

(54) Cross-Well Correlation System for Generating Predictive Visual Representations of Electric Submersible Pump Behavior from Multimodal Telemetry

(71) Applicant: AtomBeam Technologies Inc., Moraga, CA (US)

(72) Inventor: Brian Galvin, Silverdale, WA (US)

(21) Appl. No.: 19/424,194

(22) Filed: Dec. 18, 2025

Related U.S. Application Data
(63) Continuation-in-part of application No. 19/412,830, filed on Dec. 8, 2025.
Application No. 19/412,830 is a continuation-in-part of application No. 19/401,343, filed on Nov. 25, 2025.
Application No. 19/401,343 is a continuation-in-part of application No. 19/390,468, filed on Nov. 14, 2025.
Application No. 19/390,468 is a continuation-in-part of application No. 19/380,869, filed on Nov. 5, 2025.
Application No. 19/380,869 is a continuation-in-part of application No. 19/369,319, filed on Oct. 26, 2025.
Application No. 19/369,319 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/369,319 is a continuation-in-part of application No. 19/328,179, filed on Sep. 14, 2025.
Application No. 19/328,179 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 18/537,728 is a continuation-in-part of application No. 19/329,369, filed on Sep. 15, 2025.
Application No. 19/329,369 is a continuation-in-part of application No. 19/328,199, filed on Sep. 14, 2025, now Pat. No. 12,645,884.
Application No. 19/328,199 is a continuation-in-part of application No. 19/328,179, filed on Sep. 14, 2025.
Application No. 19/328,179 is a continuation-in-part of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
Application No. 19/390,468 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,889, filed on Jul. 21, 2025.
(60) Provisional application No. 63/887,491, filed on Sep. 24, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method are provided for predicting the future behavior of electric submersible pumps using sensor data collected from down-hole and surface equipment. The system processes this data to model the internal operating state of the pump as a geometric structure that reflects physical relationships and time-based changes. It compares current pump conditions to historical patterns from other installations and uses that information to forecast how the pump is likely to perform over time. These predictions are transformed into visual representations that show possible future flow patterns, mechanical stress, and signs of wear or failure. Based on this information, the system provides recommendations for adjusting pump operation or scheduling maintenance to reduce risk. By combining live data, past experience, and predictive modeling, the system helps operators make proactive decisions that improve pump reliability and field performance across multiple wells.

### CROSS-REFERENCE TO RELATED APPLICATIONS

Priority is claimed in the application data sheet to the following patents or patent applications, each of which is expressly incorporated herein by reference in its entirety:
Ser. No. 19/412,830
Ser. No. 19/401,343
Ser. No. 19/390,468
Ser. No. 19/380,869
Ser. No. 19/369,319
Ser. No. 19/363,675
Ser. No. 19/351,286
Ser. No. 19/321,173
Ser. No. 19/284,115
Ser. No. 19/051,193
63/847,082
63/847,091
63/847,096
63/847,101
Ser. No. 19/328,179
Ser. No. 19/326,730
Ser. No. 19/321,173
63/847,889
Ser. No. 19/245,366
Ser. No. 19/204,525
Ser. No. 19/192,215
Ser. No. 18/972,797
Ser. No. 18/648,340
Ser. No. 18/427,716
Ser. No. 18/410,980
Ser. No. 18/537,728
63/887,491
Ser. No. 19/329,369
Ser. No. 19/328,199
Ser. No. 19/328,179
Ser. No. 19/328,103
Ser. No. 19/326,730
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention relates to the field of machine-implemented data processing and visualization systems, and more specifically to systems and methods for generating predictive, uncertainty-aware visual representations of electric submersible pump behavior in oil and gas artificial lift operations using correlated telemetry and latent manifold encoding.

### Discussion of the State of the Art

Electric submersible pumps (ESPs) are widely used in oil and gas production to provide artificial lift in wells where reservoir pressure is insufficient to sustain natural flow. Modern ESP systems are instrumented with a variety of down-hole and surface sensors that measure parameters such as vibration, pressure, flow rate, temperature, motor current, and acoustic emissions. These data streams are typically transmitted to surface control units or supervisory control and data acquisition (SCADA) systems for monitoring and analysis. Conventional approaches display this telemetry through dashboards, trend plots, or static threshold alarms that inform operators of current pump conditions. While such tools provide visibility into real-time operation, they offer limited insight into the evolving mechanical and hydraulic states of the pump or its probable future behavior.

Efforts to improve ESP monitoring have incorporated model-based simulators and physics-driven analytical tools that predict hydraulic performance, pressure drop, or flow regime transitions. However, these simulators require explicit physical models, detailed input parameters, and manual configuration for each well. They cannot easily integrate heterogeneous sensor modalities or adapt to deviations from assumed operating conditions such as changes in gas-oil ratio, fluid viscosity, or mechanical wear. Similarly, machine-learning methods applied to ESP telemetry are often constrained to scalar anomaly detection or efficiency estimation, providing no physically interpretable visualization of predicted pump behavior or failure progression.

Consequently, operators lack tools that can transform live, heterogeneous ESP telemetry into forward-looking, visually intuitive predictions of down-hole conditions and pump health. They also lack a mechanism for correlating the behavior of one pump with historical data from other installations to identify early indicators of failure or to optimize deployment and maintenance decisions across a field.

What is needed is a machine-implemented system that encodes multimodal ESP telemetry within a physically consistent latent manifold, forecasts future operating states through geometric and probabilistic computation, and generates predictive visualizations that illustrate anticipated pump behavior and failure modes providing interpretable, auditable, and actionable insight across individual and distributed ESP installations.

### SUMMARY OF THE INVENTION

Accordingly, the inventor has conceived and reduced to practice a computer-implemented system and method for generating predictive visual representations of electric submersible pump (ESP) behavior from heterogeneous sensor data collected across multiple well installations. The invention transforms multimodal telemetry-comprising vibration, acoustic, flow, pressure, thermal, motor current, and rotational measurements-into a unified latent geometric manifold that preserves pump physics, temporal correlations, and cross-well relationships. Through Lorentzian latent dynamics, geodesic forecasting, stochastic perturbations, and cross-installation correlation, the system produces auditable, uncertainty-aware visualizations depicting the anticipated evolution of ESP operation, degradation, and failure modes, and generates actionable recommendations to optimize field performance and maintenance strategies.

In an embodiment, a computer system maintains a persistent cognitive substrate incorporating a latent manifold that represents pump operating states across multiple installations. The system receives and encodes telemetry data from ESP sensors into tensor-preserving latent representations that maintain geometric and temporal relationships reflecting pump physics. It correlates the encoded telemetry with historical operational patterns from other pumps by computing similarity metrics within the latent manifold, and computes predictive trajectories through the manifold using geodesic forecasting, stochastic perturbation kernels, or cross-installation pattern matching. The predictive trajectories represent the anticipated evolution of ESP operating states over a configurable horizon. The system applies domain-specific projection operators that transform these trajectories into visual manifold coordinates representing internal pump conditions, fluid flow regimes, and component degradation states. From these coordinates, the system generates synthetic visual outputs that depict predicted future states of the pump and provides operational recommendations derived from correlations between current trajectories and historical outcomes observed across related installations.

In an aspect of an embodiment, the correlation process identifies other pump installations with similar fluid compositions, operating depths, and mechanical configurations, where the similarity metrics are weighted by geodesic distances in the latent manifold adjusted for fluid and mechanical correspondence.

In an aspect of an embodiment, domain-specific projection operators include a cavitation visualization operator that maps pressure field tensors to bubble volume fraction distributions relative to vapor pressure, allowing the synthetic visual output to display regions of bubble nucleation and collapse within impeller passages.

In an aspect of an embodiment, the system maintains a failure mode signature library containing characteristic trajectory patterns for gas locking, sand erosion, scale deposition, and bearing degradation. Predictive trajectory computation includes matching current latent positions against these stored signatures to estimate time-to-failure distributions.

In an aspect of an embodiment, operational recommendations include adjusting pump rotational speed, injection rate, or choke position to maintain operation within a stable latent region bounded by gas lock, cavitation, and resonance thresholds.

In an aspect of an embodiment, the system performs federated prediction across geographically distributed oil fields, enabling multiple ESP monitoring systems to exchange predictive trajectories anchored by canonical ESP performance landmarks while preserving local computational sovereignty and data privacy.

In an aspect of an embodiment, telemetry encoding applies hydraulic affinity transformations that normalize pump performance curves across speed and viscosity variations so that the latent manifold represents pump behavior independently of transient conditions.

In an aspect of an embodiment, the generated synthetic visual output presents multi-layer renderings showing fluid flow streamlines through pump stages, mechanical stress fields on impeller surfaces, and probability density overlays that indicate predicted degradation, all evolving temporally over a user-defined prediction horizon.

In an aspect of an embodiment, the system performs a sleep-state consolidation process comparing predicted trajectories with subsequently observed outcomes across pumps. The process refines manifold curvature penalties and transition operators in regions corresponding to specific failure modes to improve future prediction accuracy for similar pump configurations and conditions.

The method embodiments corresponding to the foregoing system embodiments perform the same functional operations in software-executed form, including telemetry ingestion, latent encoding, correlation, forecasting, projection, visualization, and recommendation generation. For brevity, these method versions are not restated separately here but apply equivalently to the processes described above.

### BRIEF DESCRIPTION OF THE DRAWING FIGURES

FIG. 1 is a block diagram illustrating an exemplary system architecture for ESP-focused predictive visualization based on latent manifold modeling of sensor data.

FIG. 2 is a block diagram illustrating an exemplary cross-well correlation and knowledge transfer subsystem for identifying similar pump behaviors across distributed installations.

FIG. 3 is a block diagram illustrating an exemplary internal architecture of an ESP-specific tensor encoding system for generating latent representations from telemetry and contextual data.

FIG. 4 is a block diagram illustrating an exemplary predictive rollout system configured to generate forward pump state trajectories and identify failure risk using pattern matching.

FIG. 5 is a block diagram illustrating an exemplary federated prediction framework supporting bidirectional experience sharing and manifold alignment across multiple ESP monitoring nodes.

FIG. 6 is a flow diagram illustrating an exemplary end-to-end predictive visualization process from telemetry acquisition through operational recommendation generation.

FIG. 7 is a flow diagram illustrating an exemplary affinity transformation and normalization process that standardizes ESP performance data across speeds and viscosities.

FIG. 8 is a flow diagram illustrating an exemplary recommendation generation process that transforms predicted pump trajectories into failure prevention and maintenance guidance.

FIG. 9 is a flow diagram illustrating an exemplary multi-layer visualization synthesis process that renders temporally coherent videos of predicted flow, stress, and degradation.

FIG. 10 is a flow diagram illustrating an exemplary sleep-state consolidation process that refines manifold geometry and prediction logic based on observed pump behavior.

FIG. 11 illustrates an exemplary computing environment on which an embodiment described herein may be implemented.

### DETAILED DESCRIPTION OF THE INVENTION

The inventor has conceived and reduced to practice a system and method for generating predictive, uncertainty-aware visual representations of electric submersible pump (ESP) behavior from heterogeneous sensor data collected across one or more wells. The invention extends latent hyperspace-based predictive video rendering to the specific domain of artificial lift operations in oil and gas production. In an embodiment, a computer-implemented system may transform real-time telemetry from down-hole and surface sensors into geometric representations within a Lorentzian latent manifold that preserves both physical relationships and temporal continuity among pump operating states. Predictive trajectories may be computed through the manifold using geometric forecasting, stochastic perturbations, and cross-well correlation, resulting in visual forecasts of pump conditions, flow regimes, and degradation patterns. The resulting predictive visualizations may assist operators in understanding future pump behavior, anticipating failures, and optimizing deployment and maintenance strategies.

In an embodiment, a system may include an ESP telemetry acquisition and conditioning system that receives and preprocesses real-time sensor data from pumps installed in wells. A down-hole interface may obtain measurements such as three-phase motor current and voltage, intake and discharge pressure, motor and fluid temperature, tri-axial vibration, and acoustic emissions. A surface interface may receive complementary measurements such as wellhead pressure and temperature, surface flow rates, and variable speed drive parameters. Signal conditioning operations may include harmonic filtering to isolate pump-generated frequency bands from electrical noise, temperature compensation of pressure readings, phase-locked sampling of electrical waveforms, and wavelet-based acoustic feature extraction. Flow pulsation analysis may be performed in the frequency domain to identify cyclic instabilities. Processed data may be synchronized across modalities using common timing references and stored with metadata for subsequent manifold encoding and auditability.

In an embodiment, a contextual knowledge repository may maintain well configuration, fluid property, and operational constraint information relevant to ESP operation. Such contextual data may include pump specifications such as stage count, impeller geometry, and rated capacity; completion parameters such as tubing dimensions, perforation intervals, and packer depths; and reservoir properties such as pressure, temperature, and fluid composition. A fluid property estimator may compute dynamic characteristics including gas-oil ratio, viscosity variation, water cut, and emulsion stability as functions of pressure and temperature. An operational constraint compiler may define permissible operating envelopes including minimum and maximum flow for stability, net positive suction head requirements, temperature derating curves, and gas handling limits. These context tensors may be combined with telemetry data to constrain subsequent encoding and prediction within physically consistent regions.

In an embodiment, an ESP-specific tensor encoding system may transform heterogeneous telemetry into latent tensor representations that preserve hydraulic, mechanical, electrical, and multiphase flow relationships. A hydraulic performance encoder may represent pressure and flow measurements within a head-capacity surface embedding that preserves affinity laws, for example, proportional relationships such as H∝N² and Q∝N, where H denotes head, Q denotes flow, and N denotes rotational speed. Efficiency surfaces may be encoded with viscosity corrections, and tensors may include computed net positive suction head margins. A mechanical vibration encoder may transform vibration signals into orbit analysis tensors representing shaft motion, spectral coherence matrices representing resonance patterns, and bearing defect frequency tensors. An electrical signature encoder may transform motor current and voltage signals into tensors representing current imbalance, harmonic distortion, and power factor variation indicative of rotor eccentricity or insulation degradation. A multiphase flow encoder may represent gas void fraction distributions, emulsion stability factors, and sand erosion indicators inferred from acoustic signatures. The encoders may operate within a Lorentzian autoencoding architecture that preserves pseudo-Riemannian geometry to maintain causal ordering and temporal correlation within latent space.

In an embodiment, an ESP latent manifold construction engine may combine the encoded tensors into a unified geometric representation of pump operation. Constraint tensors derived from contextual knowledge may be applied during manifold construction to maintain physically feasible trajectories and prevent extrapolation beyond operational limits. A pump performance submanifold may represent hydraulic operating points, where the best efficiency point acts as a geometric attractor, instability boundaries form curvature barriers, and cavitation onset regions impose high curvature penalties. A mechanical health submanifold may describe equipment condition trajectories including bearing wear progression, imbalance evolution, and fatigue accumulation. A cross-well correlation framework may align submanifolds from multiple pumps through canonical landmarks corresponding to comparable operational states. Similarity metrics may be computed using geodesic distances weighted by fluid and mechanical correspondence factors to permit meaningful comparison across pump types and well environments.

In an embodiment, an ESP-focused predictive rollout system may compute future operating trajectories within the latent manifold. A hydraulic trajectory predictor may estimate head degradation due to wear and scale accumulation, efficiency decline over time, and gas-locking probability through stochastic perturbation kernels conditioned on gas fraction tensors. A mechanical degradation forecaster may estimate bearing life consumption using reliability relationships such as the L10 bearing life equation and may compute thrust load migration and vibration amplitude evolution paths. A failure mode pattern matcher may reference a library of characteristic latent trajectories associated with known failure modes such as gas locking, cavitation, sand erosion, scale deposition, and bearing degradation. Similarity scoring between current latent states and stored signatures may be used to estimate time-to-failure distributions and risk levels for each mode. Predictive rollouts may combine geodesic reachability operators with stochastic rollouts and historical pattern matching, producing bundles of plausible evolution paths subject to compression-pressure fields that penalize physically implausible transitions.

In an embodiment, a Bayesian fusion system may merge outputs from multiple prediction sources, including geometry-based forecasts, stochastic rollouts, physics-based models, and cross-well analogies. A multi-evidence integrator may generate posterior probability distributions representing expected future pump states. An uncertainty propagation engine may quantify contributions from measurement noise, model approximation, and future operating variability. A risk-weighted posterior generator may produce confidence-bounded predictions that incorporate both physical plausibility and empirical reliability. For example, posterior distributions may be expressed as P (M_{t+τ}|evidence)∝P(observations|M_{t+τ})×P(M_{t+τ}|priors), where M_{t+τ} represents a predicted latent state, and the posterior mean and covariance describe both expected evolution and associated uncertainty.

In an embodiment, an ESP-specific projection operator library may transform latent predictions into visual manifold coordinates suitable for rendering. Operators may include a cavitation visualization operator, denoted as R_{cavitation}, that maps pressure field tensors to bubble volume fraction distributions based on local pressure differentials relative to vapor pressure. In an embodiment, the cavitation visualization operator may compute a cavitation index defined as

$$σ = \frac{{p}_{l o c a l} - {p}_{v a p}}{0.5 ρ {v}^{2}}$$

where p_{local} represents local fluid pressure, pᵥₐₚ represents vapor pressure, ρ denotes fluid density, and ν denotes flow velocity. The computed cavitation index may be used to parameterize visual properties such as bubble size, opacity, or color intensity within predicted regions of cavitation onset and collapse. Other operators may include Rₑᵣₒₛᵢₒₙ projecting sand impact patterns on impeller surfaces, R_{scale} mapping deposition rates to layer thickness, R_{gaslift} rendering gas slug formation and migration, and R_{turbulence} visualizing recirculation zones within flow paths. Mechanical condition operators such as R_{shaft}, R_{bearing}, and Rₜₕᵣᵤₛₜ may transform latent features into visual representations of rotor orbit, bearing contact stress, and axial deformation. These transformations may be differentiable, maintain Lorentzian temporal causality, and operate under conservation constraints relevant to pump physics.

In an embodiment, a predictive video synthesis cortex may generate multi-view, temporally coherent visualizations showing anticipated pump and flow behavior. The video output may include cutaway views of pump internals, flow streamlines through impeller passages, dynamic pressure and velocity fields, and overlays of mechanical vibration modes. Temporal coherence enforcement may ensure smooth transitions and causal sequencing of degradation events. An uncertainty visualization layer may modulate opacity as a function of prediction variance, apply branching overlays when multiple futures are probable, and delineate confidence boundaries derived from posterior covariance. Each transformation and prediction state may be recorded through manifold journaling to maintain reversible mappings between visual outputs, latent states, and source telemetry.

In an embodiment, a cross-well correlation and knowledge transfer system may identify analogous pump installations based on geometric proximity within the manifold, matching fluid conditions, and operational similarity. Historical performance data may be adapted through scaling and transformation operations to reflect current pump conditions. A field optimization advisor may aggregate correlated insights across pumps to recommend deployment depths, rotational speeds, and maintenance intervals that maximize overall yield while minimizing downtime. Recommendations may be traceable to specific latent relationships and archived analogies, ensuring interpretability and auditability.

In an embodiment, an operational decision support interface may generate actionable guidance for operators. Recommended interventions may include adjusting pump speed to avoid gas lock, modifying injection rates to mitigate scale formation, or managing choke position to prevent cavitation. Maintenance planning may be based on risk-weighted failure probabilities and may include scheduling of workovers, procurement of spare components, and crew mobilization. A production optimization layer may balance multi-well output through coordinated control of individual ESPs, guided by predicted field-level behavior. All recommendations may include uncertainty measures and explicit references to the predictive evidence supporting each action.

In an embodiment, federated operation may permit distributed pump monitoring systems across geographically separated fields to exchange predictive trajectories. Data may be serialized with canonical ESP landmarks to maintain geometric alignment across local latent manifolds. Privacy-preserving computation such as homomorphic encryption or federated averaging may be employed to maintain local data control while enabling global refinement of prediction parameters. Consensus-based methods such as manifold barycenters or product-of-experts formulations may be applied to aggregate distributed posterior distributions. All exchanges may be recorded with cryptographic verification to ensure traceability.

In an embodiment, a sleep-state consolidation process may periodically evaluate predictive performance against actual outcomes. The system may compute geodesic distance errors between predicted and observed latent positions and adjust manifold curvature penalties in regions corresponding to consistent prediction discrepancies. Transition operators and normalization parameters may be refined using gradient-based or stochastic optimization methods to improve forecast accuracy without compromising stability. Over successive cycles, this adaptive refinement process allows the predictive model to evolve with field experience, maintaining alignment between geometric representation and real-world ESP behavior.

Through these combined features, a computer-implemented system may continuously transform ESP telemetry into interpretable, predictive visualizations of future pump operation. The system may maintain a persistent cognitive substrate encompassing encoding, forecasting, fusion, visualization, and decision layers, all linked through reversible manifold journaling to ensure traceability from rendered prediction back to originating telemetry and contextual evidence. In operation, the system may enable proactive identification of failure modes, informed operational adjustments, and coordinated optimization of artificial lift performance across wells and fields.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “electric submersible pump” or “ESP” refers to a down-hole artificial lift device comprising a multi-stage centrifugal pump, typically driven by a three-phase induction motor, used to lift production fluids in oil and gas wells.

As used herein, “telemetry” refers to real-time or recorded sensor data acquired from down-hole or surface instrumentation associated with an ESP installation, including but not limited to vibration, pressure, flow, temperature, acoustic, and electrical parameters.

As used herein, “latent manifold” refers to a multidimensional geometric representation constructed from encoded telemetry and contextual data, in which each point corresponds to a structured internal state of a pump system, and through which pump behavior may be modeled, predicted, or visualized.

As used herein, “latent tensor” refers to a structured numerical representation derived from ESP telemetry and contextual parameters using encoding operations, preserving physical relationships and temporal correlations for further geometric modeling.

As used herein, “geodesic forecasting” refers to a prediction method that computes likely future states of a pump system by projecting trajectories along geodesics, or shortest paths, through the latent manifold, optionally incorporating uncertainty propagation.

As used herein, “manifold journaling” refers to the persistent recording of mappings between ESP telemetry, encoded latent tensors, predicted trajectories, visual outputs, and contextual data, supporting traceability, reversibility, and auditability of system outputs.

As used herein, “failure mode signature” refers to a characteristic pattern or trajectory within latent space associated with a specific type of ESP degradation or failure, such as gas locking, cavitation, sand erosion, scale deposition, or bearing wear.

As used herein, “cross-well correlation” refers to the process of identifying similarities between ESP operational states across different wells or installations, based on geometric proximity within the latent manifold and alignment to canonical performance landmarks.

As used herein, “projection operator” refers to a transformation function that maps latent manifold coordinates to physical or visual variables such as flow patterns, mechanical stress fields, cavitation regions, or degradation overlays.

As used herein, “predictive trajectory” refers to a sequence of latent manifold coordinates computed by the system to represent anticipated future states of an ESP system over a configurable prediction horizon.

As used herein, “uncertainty quantification” refers to the computation of statistical confidence intervals, probability distributions, or variance measures associated with predicted ESP states or failure risks, based on sensor noise, model variability, or operational factors.

As used herein, “federated prediction” refers to distributed prediction across multiple ESP systems or installations, where data or model outputs are shared in a privacy-preserving manner using canonical landmarks, without requiring centralized aggregation of raw telemetry.

Conceptual Architecture of a System for Generating Predictive Visual Representations of Electrical Submersible Pump Behavior from Distributed Sensor Networks

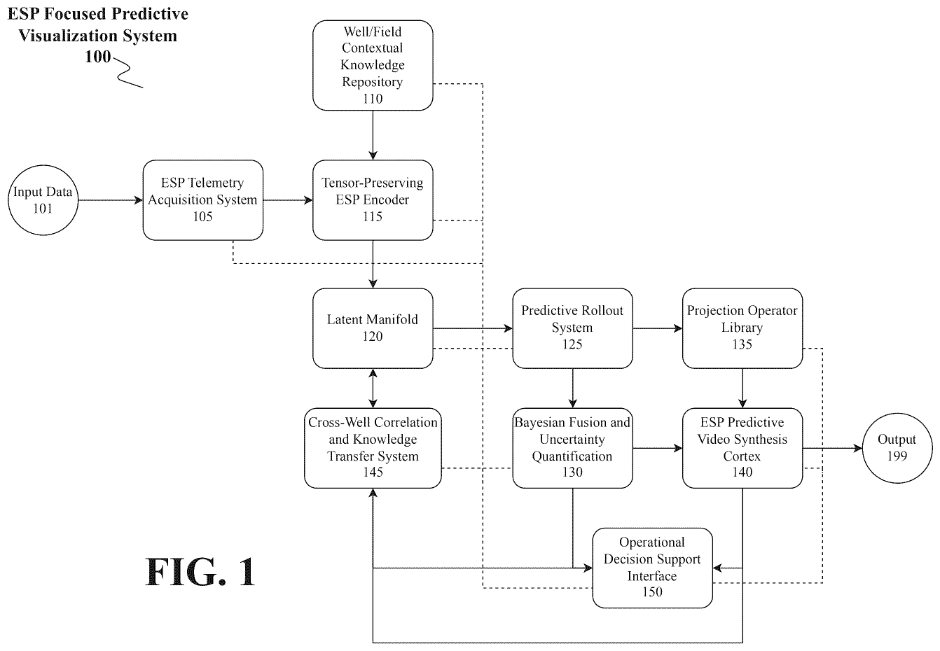

FIG. 1 is a block diagram illustrating exemplary architecture of an electric submersible pump (ESP) focused predictive visualization system 100, in an embodiment. Input data 101 comprising heterogeneous ESP telemetry streams enters the system from multiple sources including down-hole sensors measuring vibration, pressure, temperature, motor current, and acoustic emissions, as well as surface instrumentation capturing wellhead conditions, flow rates, and variable speed drive parameters. An ESP telemetry acquisition and conditioning system 105 receives and preprocesses input data 101 through signal conditioning operations including harmonic filtering to isolate pump-generated frequencies, temperature compensation for pressure measurements, phase-locked sampling of electrical parameters, and wavelet-based acoustic signature extraction. A well and field contextual knowledge repository 110 maintains comprehensive operational context including pump specifications, completion details, reservoir properties, fluid characteristics, and operational constraints that define feasible operating envelopes, providing contextual tensors that augment the conditioned telemetry for subsequent processing.

The telemetry acquisition system 105 and contextual repository 110 feed an ESP-specific tensor encoding system 115 that transforms heterogeneous measurements into latent tensor representations through specialized encoders for hydraulic performance, mechanical vibration, electrical signatures, and multiphase flow phenomena while preserving pump physics relationships and temporal correlations. The encoded tensors flow into an ESP latent manifold construction engine 120 that builds a unified geometric representation integrating pump performance submanifolds with best efficiency points as attractors, mechanical health submanifolds with monotonic degradation trajectories, and cross-well correlation frameworks enabling experience transfer across installations. An ESP-focused predictive rollout system 125 receives manifold states from engine 120 and computes forward trajectories using hydraulic trajectory predictors for head degradation and efficiency decline, mechanical degradation forecasters for bearing life consumption and vibration growth, and failure mode pattern matchers that compare current positions against historical signatures for gas lock, cavitation, and sand erosion.

The rollout system 125 provides predicted trajectories to both an ESP Bayesian fusion and uncertainty quantification system 130 and an ESP-specific projection operator library 135, where the Bayesian system 130 integrates physics-based models, data-driven patterns, and cross-well analogies through multi-evidence fusion to produce risk-weighted posterior distributions with explicit uncertainty bounds. The projection operator library 135 applies domain-specific transformations including cavitation operators mapping pressure fields to bubble distributions, erosion operators projecting sand impact patterns, scale operators computing deposition thickness, and mechanical operators representing shaft orbits and bearing stress fields, converting latent trajectories to visual manifold coordinates. An ESP predictive video synthesis cortex 140 receives visual coordinates from library 135 and uncertainty measures from fusion system 130 to generate output 199 comprising multi-view synthetic predictive video showing pump internals, flow streamlines through impeller passages, and degradation progression with temporal coherence enforcement and uncertainty visualization through opacity modulation and confidence boundaries.

A cross-well correlation and knowledge transfer system 145 serves as the primary bridge for federated ESP prediction across geographically distributed oil fields, maintaining canonical ESP performance landmarks that enable alignment between local manifolds at different installations while preserving computational sovereignty over proprietary operational data. System 145 packages local predictive trajectories with canonical landmark references for sharing with remote pump installations, receives and translates trajectories from other installations into the local manifold context through similarity matching and fluid property normalization, and aggregates distributed predictions using consensus methods such as manifold barycenters or product-of-experts formulations. The federated communication through system 145 enables each ESP installation to leverage collective field experience for improved predictions while maintaining local control, with system 145 providing translated insights to both the manifold construction engine 120 and an operational decision support interface 150. The operational decision support interface 150 receives inputs from the Bayesian fusion system 130 and cross-well correlation system 145, analyzing both local predictions and federated insights to derive operational recommendations including failure prevention interventions, maintenance scheduling parameters, and production optimization strategies that coordinate across multiple wells in the federation.

Interface 150 generates feedback signals that return to the latent manifold construction engine 120, enabling sleep-state consolidation processes that compare predicted trajectories against subsequently observed operational outcomes to refine manifold curvature penalties and improve future prediction accuracy for both local and federated predictions. This feedback architecture creates a continuous learning loop where the system adapts its predictive models based on actual pump performance from both local operations and federated experience sharing, while maintaining reversible mappings through manifold journaling for complete traceability from the synthetic video output 199 back through all processing stages to the originating input data 101.

The federated architecture coordinated through system 145 enables the predictive visualization system 100 to operate as part of a larger distributed intelligence network, where multiple ESP installations share predictive trajectories and learned patterns while maintaining privacy-preserving computation and local computational control over sensitive operational parameters.

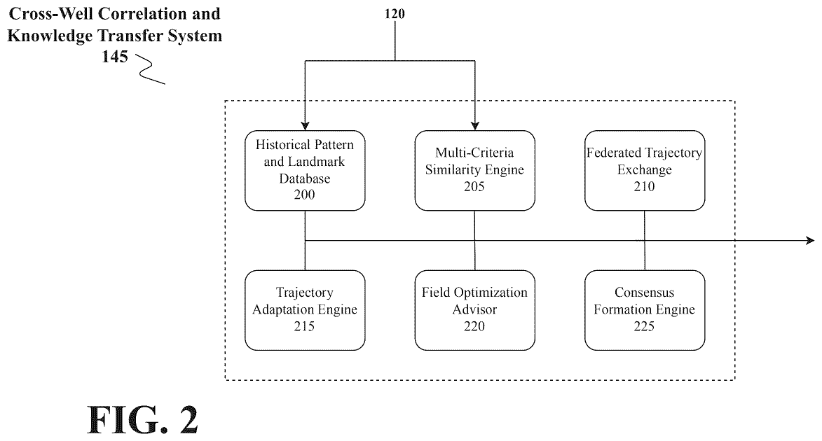

FIG. 2 is a block diagram illustrating exemplary architecture of an exemplary cross-well correlation and knowledge transfer subsystem for correlating current ESP operational data with historical patterns from multiple pump installations, in an embodiment. Input data comprising local ESP latent state representations enters the system from a manifold construction engine 120, where the latent state encodes current pump operational conditions including hydraulic performance, mechanical health indicators, and fluid characteristics. A historical pattern and landmark database 200 maintains canonical ESP performance landmarks, multi-well operational trajectories, failure mode signatures, and annotated intervention outcomes across a plurality of pump installations, providing reference patterns for correlation and comparison operations. A multi-criteria similarity engine 205 receives the local ESP latent state and queries the historical pattern and landmark database 200 to compute geodesic distance metrics within the latent manifold, applies fluid property correspondence weighting factors, evaluates mechanical configuration similarity scores, and performs operating envelope matching to identify and rank analogous installations with comparable operational characteristics.

The multi-criteria similarity engine 205 and historical pattern and landmark database 200 provide inputs to a federated trajectory exchange 210 that implements privacy-preserving protocols for sharing predictive trajectories across geographically distributed oil fields while anchoring shared data to canonical landmark references maintained in database 200. Federated trajectory exchange 210 supports bidirectional communication with remote ESP installations, enabling the system to transmit locally-derived predictive insights and receive trajectory data from other pump installations in the distributed network. The exchange 210 incorporates cryptographic verification mechanisms to authenticate data sources and detect potential tampering during cross-installation data transfers. Both the historical pattern and landmark database 200 and the multi-criteria similarity engine 205 feed trajectory data to a trajectory adaptation engine 215 that applies scaling transformations to normalize performance curves across different pump configurations, performs local manifold mapping operations to translate remote installation trajectories into the local manifold coordinate system, and executes context normalization to account for differences in fluid properties and operating conditions between installations.

Trajectory adaptation engine 215 includes applicability verification logic that assesses whether historical patterns from analogous installations maintain sufficient similarity to support reliable knowledge transfer, and implements transfer quality validation to quantify confidence in adapted trajectory predictions. A field optimization advisor 220 receives inputs from both the multi-criteria similarity engine 205 and the trajectory adaptation engine 215 to generate multi-well production coordination strategies, deployment depth recommendations based on correlated performance data, maintenance interval optimization derived from observed degradation patterns across analogous pumps, and field-level performance strategies that balance production objectives against equipment reliability considerations. A consensus formation engine 225 receives trajectory predictions from the federated trajectory exchange 210 and validated adapted trajectories from the trajectory adaptation engine 215, then applies manifold barycenter computation methods to merge predictions from multiple sources, implements product-of-experts fusion techniques to combine independent prediction distributions, performs distributed posterior merging operations to integrate probabilistic forecasts, and generates federated prediction aggregates that incorporate insights from the broader network of installations.

The trajectory adaptation engine 215 provides correlated insights and refined trajectory predictions to the manifold construction engine 120, enabling the local predictive system to incorporate knowledge derived from analogous installations into its forecasting operations. The field optimization advisor 220 transmits field optimization recommendations and multi-well coordination strategies to an operational decision support interface 150 where operators can evaluate and implement suggested interventions. The consensus formation engine 225 returns aggregated predictive insights to the federated trajectory exchange 210 for distribution to remote ESP installations, creating a bidirectional knowledge sharing architecture that supports continuous learning across the distributed network while maintaining local computational control over proprietary operational data.

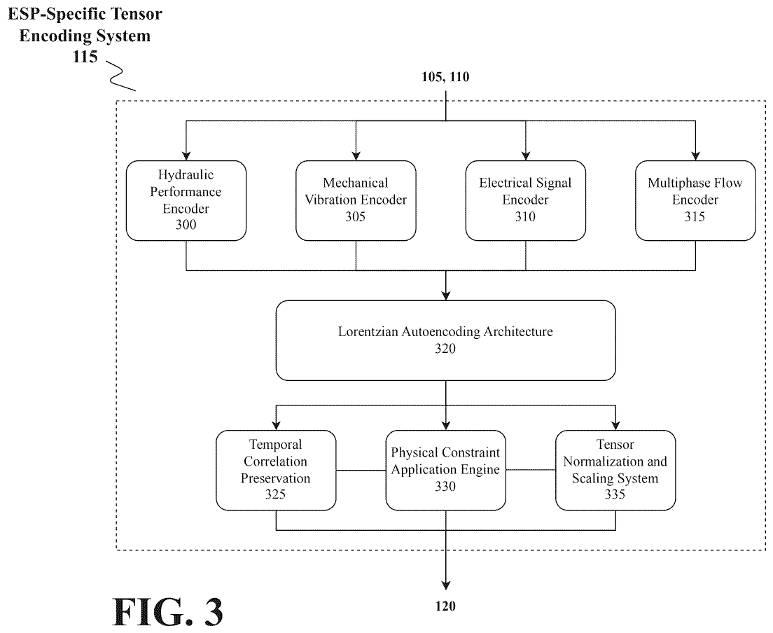

FIG. 3 is a block diagram illustrating an exemplary internal architecture of an ESP-specific tensor encoding system 115, in an embodiment. Encoded outputs from this system are provided to an ESP latent manifold construction engine 120, where they are incorporated into unified geometric representations that support predictive modeling, cross-installation comparison, and synthetic visualization.

Conditioned telemetry data enters from an ESP telemetry acquisition and conditioning system 105, comprising preprocessed measurements from down-hole and surface sensors including vibration signals, pressure readings, flow rates, temperature data, motor electrical parameters, and acoustic emissions. Contextual knowledge tensors arrive from a well and field contextual knowledge repository 110, carrying pump specifications, completion parameters, fluid properties, and operational constraint data. These tensors inform encoding processes and apply physical feasibility constraints during tensor formation.

A hydraulic performance encoder 300 receives the conditioned telemetry data and contextual tensors and constructs head-capacity embeddings that preserve affinity law relationships, generates efficiency surfaces adjusted for viscosity effects, computes net positive suction head margin tensors, and encodes pressure-flow relationships across multiple operational regimes. A mechanical vibration encoder 305 processes tri-axial vibration inputs and contextual knowledge to produce orbit analysis tensors, spectral coherence matrices characterizing resonance modes, encoded bearing fault indicators derived from vibration frequency content, harmonic-based imbalance metrics, and thrust load variation representations associated with axial force dynamics.

An electrical signature encoder 310 transforms current and voltage telemetry into tensors representing three-phase motor behavior, quantifies current imbalance across phases, characterizes harmonic distortion patterns, extracts rotor eccentricity signatures from current signal variation, and produces insulation condition indicators from high-frequency electrical characteristics. A multiphase flow encoder 315 receives acoustic signatures, flow telemetry, and fluid property tensors to estimate gas void fraction along pump stages, compute emulsion stability based on fluid composition and flow regime features, extract sand impact signatures correlated with acoustic scattering behavior, and encode flow regime indicators that may correspond to bubble, slug, churn, or annular flow conditions. These encoders annotate outputs with semantic features that may be used by projection operators to generate domain-specific renderings of pump internals, flow transitions, and mechanical degradation.

A Lorentzian autoencoding architecture 320 receives the output tensors from the hydraulic, mechanical, electrical, and flow encoders. This architecture constructs a unified latent representation that preserves pseudo-Riemannian structure across encoding domains and applies a metric signature configured to maintain causal separation of temporally adjacent states. Geometric constraints informed by contextual knowledge are applied to avoid latent representations that deviate from physically consistent behavior. The architecture maintains coupling between domains to reflect interdependence of electrical, mechanical, and hydraulic dynamics during pump operation. Tensor outputs retain identifiers that link them to the originating sensor features and timestamps to support traceability and manifold journaling.

A temporal correlation preservation system 325 receives outputs from the Lorentzian autoencoding architecture and encodes state transitions over time, representing degradation processes as temporally coherent trajectories and filtering out latent discontinuities that may not correspond to real-world operating conditions. This subsystem is configured to maintain continuity in latent space for systems exhibiting gradual changes in vibration, efficiency, or flow response.

A physical constraint application engine 330 refines the latent representations by applying conservation relationships including fluid mass balance, energy exchange, and momentum transfer constraints. The engine references contextual knowledge to constrain latent coordinates to operational envelopes defined by manufacturer specifications, validated pressure-temperature boundaries, and fluid phase behavior. It supports thermodynamic consistency by excluding representations that deviate from empirical phase relationships or violate applicable hydraulic principles.

A tensor normalization and scaling system 335 transforms latent outputs to enable field-wide comparison by applying affinity transformations that normalize pump behavior across different rotational speeds and viscosities. It also supports scaling across ESP configurations with varying rated capacities or stage counts. This processing yields dimensionless latent coordinates that may be compared across installations and transmitted to federated prediction systems for further use. The representations are also tagged with indicators that may guide domain-specific projection operators in subsequent visualization steps.

The latent outputs from components 325, 330, and 335 are transmitted to an ESP latent manifold construction engine 120, where they are assembled into structured submanifolds that support predictive rollout, projection, and operational decision systems. These outputs preserve temporal continuity, physical interpretability, and geometric structure, and support reverse mapping from visualizations back to the original conditioned telemetry and contextual tensors through manifold journaling.

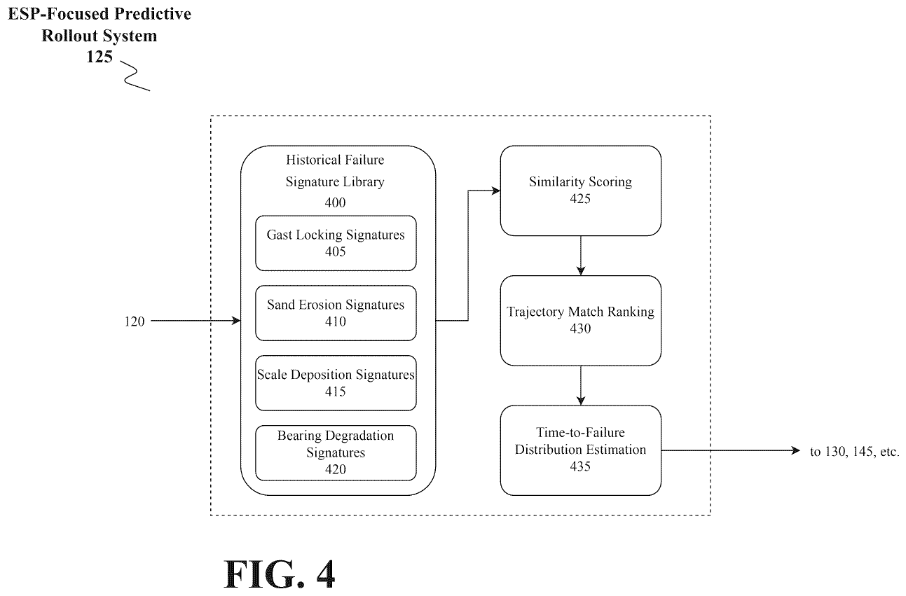

FIG. 4 is a block diagram illustrating exemplary architecture of an ESP-focused predictive rollout system 125, in an embodiment. Input data comprising current ESP latent state representations enters from an ESP latent manifold construction engine 120, where the latent state encodes operational characteristics derived from telemetry and contextual knowledge, including hydraulic performance metrics, mechanical condition indicators, and fluid property tensors. These latent states represent temporally ordered operating trajectories encoded within a Lorentzian manifold constructed from sensor data and contextual constraints.

System 125 includes multiple predictive subsystems configured to estimate future evolution of pump operating conditions. A failure mode pattern matcher receives the current latent state and evaluates its correspondence with known failure trajectory patterns to identify incipient degradation. A historical failure signature library 400 stores characteristic latent trajectories representing progression toward distinct failure modes, organized into signature collections that include gas locking signatures 405, sand erosion signatures 410, scale deposition signatures 415, and bearing degradation signatures 420. These collections encode prior observations of pump failure behavior drawn from recorded latent telemetry trajectories across multiple ESP installations and well environments.

The gas locking signatures 405 may include trajectory fragments representing rapid pressure decline, gas void fraction accumulation, and flow instability behaviors. The sand erosion signatures 410 may include sequences derived from acoustic impact evolution, pump efficiency reduction correlated with impeller wear, and material removal progression over time. The scale deposition signatures 415 may include patterns reflecting head degradation due to mineral deposition, latent pressure-flow constraints arising from stage blockages, and flow regime transitions that precede scaling events. The bearing degradation signatures 420 may include latent trajectories describing vibration growth, spectral frequency migration associated with rotating machinery wear, and energy dissipation patterns under variable loading.

A similarity scoring in latent space subsystem 425 receives the current latent state and accesses stored failure trajectories from library 400. It computes geodesic similarity metrics that reflect distance through the latent manifold, taking into account its curvature and the temporal ordering of latent coordinates. These similarity scores quantify alignment between current pump behavior and historical progression toward failure modes. A trajectory match ranking subsystem 430 receives the computed similarity scores and produces an ordered set of failure conditions based on both instantaneous position alignment and recent historical evolution of the pump's latent state trajectory. The ranking reflects which failure progressions exhibit the strongest correspondence to present operation, weighted by temporal congruence and latent curvature distance.

A time-to-failure distribution estimation subsystem 435 receives the ranked failure conditions and computes probability distributions that characterize expected time horizons over which each failure mode may manifest. These distributions are derived from historical rates of progression observed in the signature library 400 and are conditioned on the degree of current similarity and the temporal dynamics observed in comparable cases. The subsystem produces output data comprising likelihood-ranked failure modes, estimated time-to-failure intervals, associated similarity measures, and confidence intervals based on both statistical variance in historical cases and uncertainty in current latent positioning.

The outputs from subsystems 425, 430, and 435 form the failure mode prediction path within system 125. These predictions are consolidated with outputs from a hydraulic trajectory predictor and a mechanical degradation forecaster, each configured to project latent trajectories forward based on physical modeling of pump degradation under fluid, mechanical, and electrical loads. The hydraulic predictor estimates evolution of head performance, gas handling capacity, and efficiency decline under scale or wear conditions, while the mechanical forecaster projects bearing wear, thrust migration, and vibration growth using condition-specific reliability models. These predictive paths operate on the same latent structure and temporal coordinate system used by the pattern matcher, enabling consistent integration.

The consolidated output is provided to an ESP Bayesian fusion and uncertainty quantification system 130, which synthesizes evidence across predictive mechanisms to produce posterior probability distributions over future pump operating states. These outputs may be used to inform projection operators and decision support systems. A feedback pathway from downstream processing returns observed failure progressions to the failure signature library 400 through a sleep-state consolidation mechanism. This pathway updates stored failure signatures by incorporating field-validated operating trajectories, refining latent representations and progression rates associated with known failure types. These updates adjust stored trajectories based on newly observed data, improving the accuracy of future similarity scoring and distribution estimation while maintaining geometric compatibility within the latent manifold.

Through this structure, system 125 supports predictive estimation of pump behavior using both empirical trajectory pattern matching and forward modeling of physical degradation phenomena, producing latent predictions that remain geometrically and temporally coherent within the larger manifold representation.

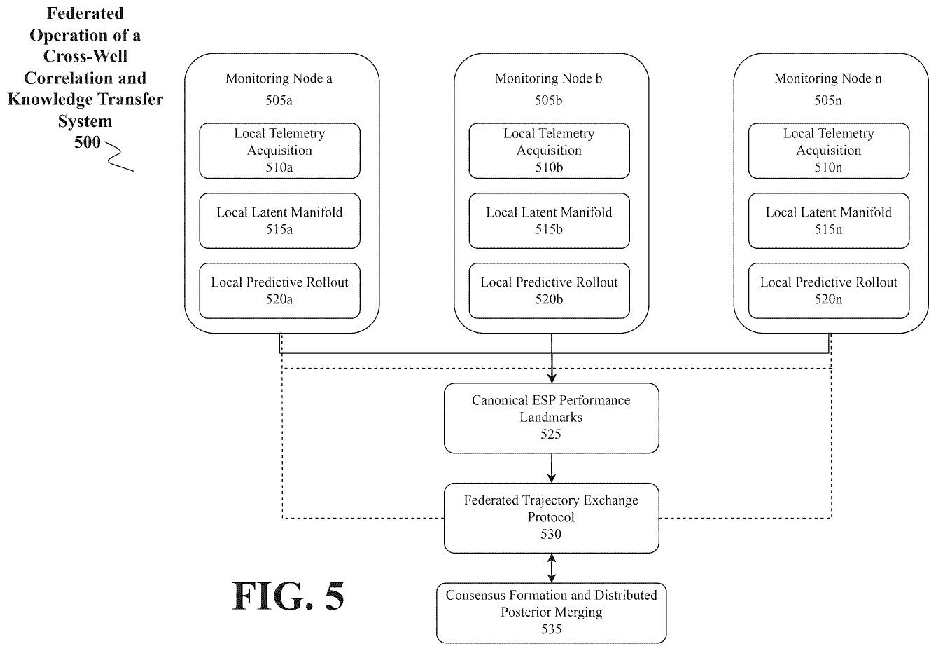

FIG. 5 is a block diagram illustrating exemplary federated operation of a cross-well correlation and knowledge transfer system 145 across geographically distributed oil field installations, in an embodiment.

The federated architecture as illustrated comprises a plurality of local ESP monitoring nodes, including node 505a deployed in Field A, node 505b deployed in Field B, and node 505n deployed in Field N. Each node operates as an instance of the predictive visualization system with its own telemetry acquisition, tensor encoding, manifold construction, and predictive rollout subsystems tailored to local well conditions, pump configurations, and operational constraints. Local latent manifolds constructed at each node incorporate telemetry-encoded representations of pump state derived from system 115 and constructed using system 120, capturing geometry that reflects site-specific fluid properties, mechanical configurations, and operational envelope constraints.

Each local node operates independently and retains computational sovereignty over proprietary operational data. Within system 145, these nodes participate in a federated trajectory exchange network configured to support bidirectional sharing of latent trajectory data anchored to a shared set of canonical ESP performance landmarks 525. These landmarks define reference states including best efficiency point positions, cavitation onset boundaries, gas lock transition conditions, and bearing degradation signatures. Each landmark is associated with specific tensor features, latent coordinates, or operating thresholds derived from a range of pump types and well environments. These shared landmarks are used to map local manifold regions to a common geometric context without requiring transformation of raw telemetry or exposure of sensitive site-specific data.

Each local ESP monitoring node transmits predictive trajectories, generated by its rollout subsystem 520a, 520b, or 520n, to the federated trajectory exchange protocol 530. Trajectories are serialized with canonical landmark references to preserve alignment between source and destination coordinate systems. The exchange protocol 530 is configured to perform cryptographic authentication of transmission sources and supports privacy-preserving techniques including homomorphic encryption and federated averaging. These mechanisms allow for mathematical operations on encrypted representations or distributed refinement of predictive parameters across nodes without disclosing raw data. Serialized trajectory data is transmitted from each node to the exchange protocol 530 and returned to other nodes in the network, allowing each local system to receive latent trajectories representing predictive evolution from pumps operating in different field environments.

Each receiving node uses the canonical landmark framework to transform incoming trajectories into its local manifold coordinate system. Transformation may include affine normalization, latent curvature matching, and dimensional adjustment based on shared submanifold alignment. Translated trajectories may be integrated with local pattern matching subsystems or used to augment predictive rollout processes. For example, remote degradation trajectories observed under similar viscosity, gas fraction, or loading conditions may be matched against current latent states to improve local estimation of time-to-failure distributions or identify atypical progression paths not previously encountered in the local field history.

Bidirectional data exchange is maintained for each participating node. Node 505a transmits predictive outputs from its local rollout system through canonical references to the exchange protocol and receives translated predictions from other nodes for use in its local predictive processes. Node 505b and node 505n similarly participate in exchange operations through their respective predictive rollout subsystems, each contributing local trajectories and receiving distributed predictions aligned to local coordinate structures.

A consensus formation and distributed posterior merging subsystem 535 receives trajectory inputs from the exchange protocol and aggregates distributed predictions into unified probabilistic forecasts. Subsystem 535 computes manifold barycenters across received trajectories using similarity-weighted metrics that incorporate both latent space distance and confidence measures associated with each contributing node. Product-of-experts fusion is applied to overlapping forecast distributions to generate posterior densities that reflect the level of agreement or divergence among contributing nodes. The subsystem characterizes uncertainty in the consensus output by analyzing prediction variance across the manifold and identifying regions where distributed predictions are tightly clustered or widely dispersed.

Aggregated prediction outputs from subsystem 535 are delivered back to local ESP monitoring nodes through the federated exchange protocol 530. These consensus-based insights may be integrated into local prediction workflows, used to inform failure risk assessments, or incorporated into operational decision support recommendations generated by system 150. Feedback from each node regarding observed outcomes or prediction accuracy is returned through the exchange protocol to support sleep-state consolidation, allowing participating systems to refine latent alignment and update canonical landmark associations based on field-confirmed pump behavior.

System 145 operates as a distributed knowledge transfer layer built on machine-encoded latent state representations and telemetry-derived trajectory structures. It supports federated learning and cross-well inference without requiring centralized data aggregation or disclosure of raw operational parameters, enabling predictive visualization systems at each field installation to benefit from accumulated experience across the broader pump population while maintaining alignment with local geometry, data policies, and operating conditions.

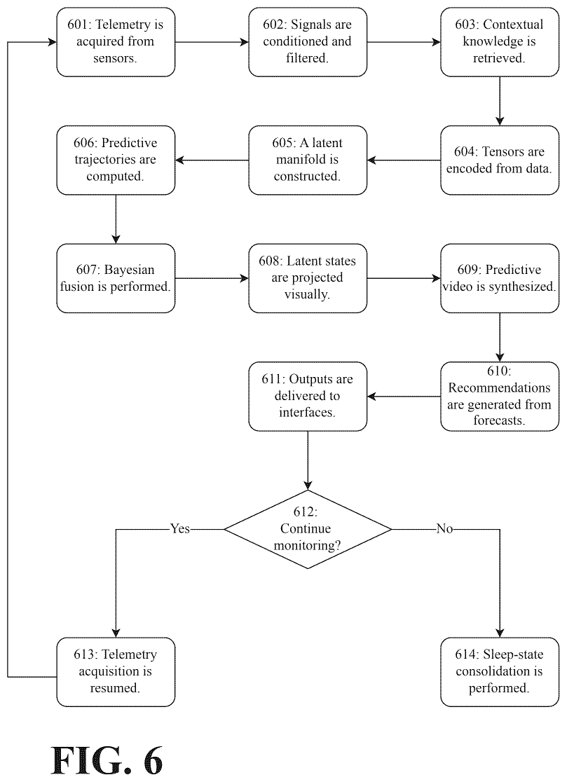

FIG. 6 is a flow diagram illustrating an exemplary end-to-end predictive visualization process from ESP telemetry acquisition through operational recommendation generation, in an embodiment. The process begins when an ESP telemetry acquisition and conditioning system 105 initiates data collection from down-hole and surface sensors monitoring one or more electric submersible pump installations, acquiring measurements including vibration signals, pressure readings, flow rates, temperature data, motor current parameters, and acoustic emissions 601. The acquired telemetry data flows to a signal conditioning operation that performs harmonic filtering to isolate pump-generated frequency bands from electrical noise, applies temperature compensation to pressure measurements, executes phase-locked sampling of motor electrical waveforms, and extracts acoustic feature content through wavelet decomposition methods 602. The conditioned telemetry data proceeds to a contextual knowledge retrieval operation that accesses a well and field contextual knowledge repository 110 to obtain pump specifications, completion details including tubing dimensions and perforation intervals, fluid property estimates including gas-oil ratio and viscosity characteristics, and operational constraint definitions specifying permissible operating envelopes 603.

The conditioned telemetry and contextual knowledge flow into an encoding operation performed by an ESP-specific tensor encoding system 115 that transforms the multimodal measurements into latent tensor representations through hydraulic performance encoding preserving affinity law relationships, mechanical vibration encoding capturing shaft dynamics and resonance patterns, electrical signature encoding representing current imbalance and harmonic distortion, and multiphase flow encoding characterizing gas void fraction and emulsion behavior 604. The encoded latent tensors proceed to a manifold construction operation performed by an ESP latent manifold construction engine 120 that integrates the tensor representations into a unified geometric structure comprising pump performance submanifolds with best efficiency points as attractors, mechanical health submanifolds with degradation trajectories, and cross-well correlation frameworks enabling alignment with operational data from other pump installations 605. The constructed latent manifold representation flows to a predictive trajectory computation operation performed by an ESP-focused predictive rollout system 125 that forecasts future operating states through hydraulic trajectory prediction of head degradation and efficiency decline, mechanical degradation forecasting of bearing life consumption and vibration growth, and failure mode pattern matching comparing current latent positions against stored signatures for gas locking, cavitation, sand erosion, scale deposition, and bearing degradation 606.

The computed predictive trajectories proceed to a Bayesian fusion operation performed by an ESP Bayesian fusion and uncertainty quantification system 130 that integrates predictions from physics-based hydraulic models, data-driven degradation patterns, and cross-well analogies from similar pump installations received through a cross-well correlation and knowledge transfer system 145, generating posterior probability distributions over future pump states with explicit uncertainty quantification accounting for measurement noise, model approximation limitations, and operational variability 607. The fused probabilistic predictions flow to a projection operation performed by an ESP-specific projection operator library 135 that transforms latent trajectory coordinates into visual manifold representations through cavitation operators mapping pressure fields to bubble volume fractions, erosion operators projecting sand impact patterns onto impeller surfaces, scale operators transforming deposition rates to thickness distributions, and mechanical condition operators representing rotor dynamics, bearing stress, and axial deformation 608. The visual manifold coordinates proceed to a synthesis operation performed by an ESP predictive video synthesis cortex 140 that generates multi-view synthetic video sequences showing cutaway views of pump internals during operation, flow streamlines through impeller passages, dynamic pressure and velocity field animations, vibration mode shape overlays, and uncertainty visualization through opacity modulation and confidence boundaries 609.

The synthesized predictive video output flows to a recommendation generation operation performed by an operational decision support interface 150 that analyzes predicted trajectories and failure probabilities to generate failure prevention interventions including adjustments to pump rotational speed to avoid gas lock conditions, modifications to chemical injection rates for scale mitigation, and management of choke positions to prevent cavitation, as well as maintenance scheduling guidance based on risk-weighted failure probabilities and production optimization strategies for multi-well coordination 610. The predictive visualization comprising synthetic video with uncertainty encoding and the operational recommendations comprising actionable guidance for equipment management flow to system output interfaces where operators and automated control systems can access the information 611. A decision operation evaluates whether continuous monitoring should proceed, comparing operational status indicators against termination criteria including pump shutdown commands, system maintenance requirements, or operator intervention requests 612. When the decision operation determines that monitoring should continue, the process returns to the telemetry acquisition operation to obtain updated sensor measurements reflecting current pump conditions and enabling ongoing predictive assessment 613.

When the decision operation determines that monitoring should not continue, the process proceeds to a sleep-state consolidation operation that compares predicted trajectories generated during the monitoring session against subsequently observed operational outcomes, computing geodesic distance errors between predicted and actual latent positions, adjusting manifold curvature penalties in regions exhibiting consistent prediction discrepancies, refining transition operators and normalization parameters to improve forecast accuracy, and updating failure mode signature patterns in the historical library based on actual failure progressions observed during the monitoring period 614.

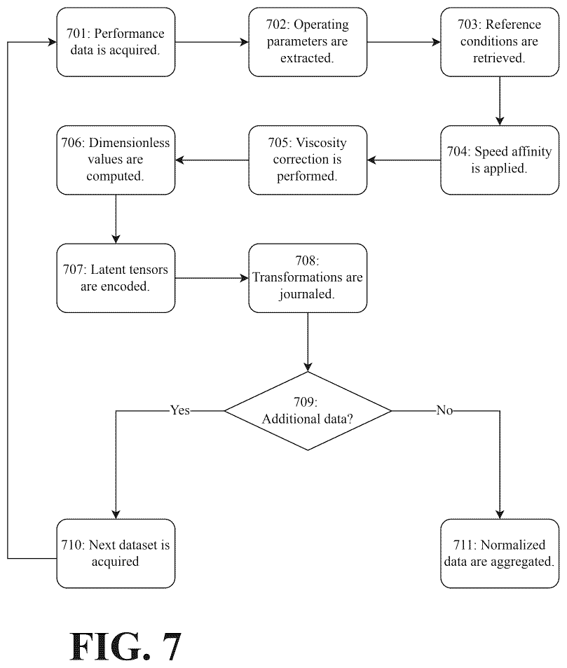

FIG. 7 is a flow diagram illustrating an exemplary hydraulic affinity transformation and normalization process that enables pump performance comparison across different rotational speeds and fluid viscosities, in an embodiment. The process begins when an ESP telemetry acquisition and conditioning system 105 provides pump performance measurements including head, flow rate, and efficiency data collected under current operational conditions characterized by specific rotational speed and fluid viscosity parameters 701. The acquired performance data flows to an extraction operation that isolates operating parameters from the telemetry stream including current rotational speed, fluid viscosity, fluid density, measured head, and measured flow rate that describe the pump's present performance state 702. The extracted operating parameters proceed to a reference condition retrieval operation that accesses a well and field contextual knowledge repository 110 to obtain reference speed specifications, standard viscosity values, and design point performance characteristics against which current measurements may be normalized 703.

The current parameters and reference conditions flow to a speed affinity transformation operation that scales head, flow, and power values to reference rotational speed conditions using proportional relationships derived from similitude principles, where in an embodiment, head may vary with the square of speed ratio, flow may vary linearly with speed ratio, and power may vary with the cube of speed ratio 704. The speed-normalized performance data proceeds to a viscosity transformation operation that computes scaling factors such as Reynolds number to characterize the relationship between inertial and viscous forces, applies viscosity-related correction factors to head and flow measurements, and adjusts efficiency estimates to reflect changes in internal friction losses when fluid viscosity deviates from reference conditions 705. The transformed performance data flows to a normalization operation that generates dimensionless performance descriptors including, in an embodiment, head coefficient and flow coefficient, where such coefficients may represent pump behavior independently of temporary speed variation, transient fluid properties, or site-specific installation differences 706.

The normalized performance curves proceed to an encoding operation performed by an ESP-specific tensor encoding system 115 that transforms the dimensionless performance representation into latent tensor form suitable for manifold construction, preserving geometric relationships needed to compare pump behavior across wells, fields, and operating conditions 707. The encoded latent representation flows to a storage operation that records the transformation parameters including speed ratios, viscosity corrections, and normalization coefficients in a manifold journal, enabling auditability and reversible transformation from normalized latent coordinates back to originating telemetry and reference frames 708. A decision operation evaluates whether additional pump performance data from other time periods or installations requires normalization, examining telemetry queues and processing priorities to determine if further transformation cycles should begin 709.

When the decision operation determines that additional pump data requires processing, the process initiates acquisition of the next dataset and returns to the performance data acquisition operation to continue transformation for other pumps or time periods 710. When the decision operation determines that all available performance data has been normalized, the process proceeds to an aggregation operation that combines normalized representations from multiple installations into a unified structure suitable for cross-well correlation and knowledge transfer using system 145, enabling distributed systems to identify comparable pump behavior despite differences in pump type, rotational speed, or fluid properties 711.

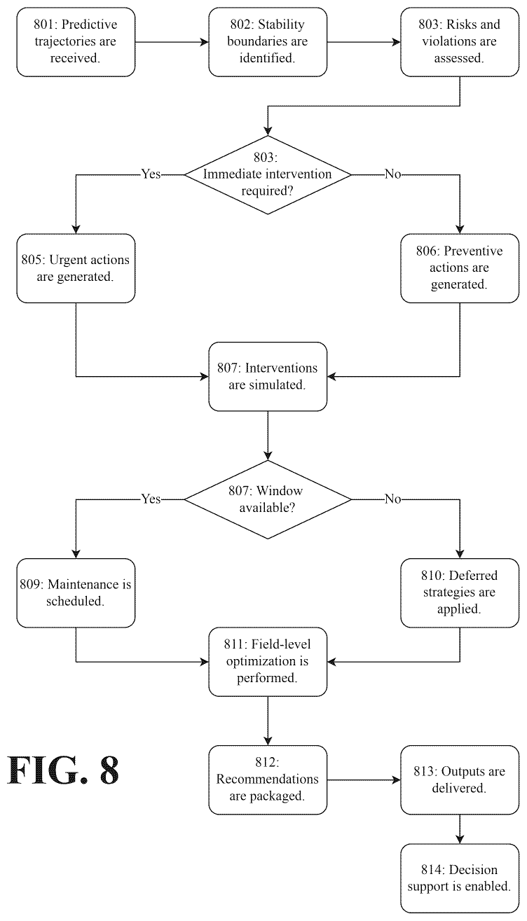

FIG. 8 is a flow diagram illustrating an exemplary operational recommendation generation process that translates predictive trajectories into actionable guidance for pump operation and maintenance, in an embodiment. The process begins when an operational decision support interface 150 receives predictive trajectory data comprising latent manifold coordinates with associated uncertainty bounds from an ESP Bayesian fusion and uncertainty quantification system 130, where the trajectories represent anticipated evolution of pump operating states over a configurable prediction horizon 801. The received predictive trajectories flow to an identification operation that locates stability boundaries within the latent manifold including gas lock onset boundaries representing conditions where gas accumulation may impede liquid pumping, cavitation threshold regions where local pressure approaches vapor pressure levels, and mechanical resonance zones where excitation frequencies may coincide with natural frequencies of rotating components 802. The identified stability boundaries proceed to an assessment operation that computes geodesic distances from predicted trajectory positions to constraint regions throughout the prediction horizon, evaluates boundary violation probabilities based on trajectory uncertainty envelopes, and analyzes failure mode likelihoods derived from pattern matcher outputs characterizing risks of gas locking, cavitation, sand erosion, scale deposition, and bearing degradation 803.

The risk assessment results flow to a decision operation that evaluates whether immediate intervention is required based on proximity of predicted trajectories to critical stability boundaries, magnitude of failure mode probabilities, and time remaining before anticipated boundary violations or equipment failures 804. When the decision operation determines that immediate intervention is required due to imminent risk of gas lock, cavitation, or other critical failure modes, the process proceeds to an urgent intervention generation operation that formulates rapid response actions including pump speed reductions to decrease flow rates and avoid gas lock conditions, choke position adjustments to modify backpressure and prevent cavitation onset, or injection rate changes to alter fluid composition and mitigate immediate threats 805. When the decision operation determines that immediate intervention is not required because predicted trajectories remain within acceptable proximity to stability boundaries over near-term horizons, the process proceeds to a preventive action generation operation that formulates longer-term operational adjustments including chemical injection programs for scale mitigation, gradual operating point modifications to maintain trajectories within stable latent regions, or parameter tuning to optimize efficiency while preserving adequate margins from constraint boundaries 806.

The urgent interventions from step 805 and preventive actions from step 806 converge at a simulation operation that projects the effects of candidate interventions by computing modified trajectory paths through the latent manifold using projection operators from system 135, evaluating how proposed speed changes, injection modifications, or choke adjustments would alter predicted pump behavior, and quantifying the degree to which each intervention option reduces boundary violation probabilities or extends anticipated time to failure 807. The simulated intervention effects flow to a decision operation that evaluates whether a maintenance window is available for implementing more substantial corrective actions, examining operational schedules to determine if planned production interruptions, rig availability, or crew mobilization opportunities exist within timeframes consistent with predicted failure progression 808. When the decision operation determines that a maintenance window is available, the process proceeds to a scheduling operation that plans workover operations including pump replacement, component refurbishment, or system reconfiguration based on risk-weighted failure probabilities, coordinating intervention timing with production requirements and resource availability to minimize operational impact while addressing identified equipment degradation 809.

When the decision operation determines that no maintenance window is available within the relevant timeframe, the process proceeds to a deferral operation that adjusts monitoring parameters to increase vigilance for early failure indicators, modifies operating setpoints to reduce stress on degrading components and extend remaining operational life, and establishes contingency protocols for rapid response if conditions deteriorate more quickly than anticipated by predictive models 810. The scheduled maintenance actions from step 809 and deferred maintenance strategies from step 810 converge at an optimization operation that coordinates recommendations across multiple pump installations within the field using field-level performance data from system 145, balancing individual equipment protection requirements against production objectives, distributing drawdown across wells to compensate for pumps operating under restricted conditions, and sequencing interventions to maintain overall output while managing equipment degradation risk 811. The optimized multi-well strategies flow to a packaging operation that formats recommendation outputs for presentation through operator interfaces supported by predictive video synthesized using system 140, including specific parameter adjustment values with associated uncertainty measures, evidence traceability linking recommendations to latent trajectories and originating telemetry, priority classifications distinguishing urgent actions from preventive measures, and confidence indicators representing the statistical reliability of underlying predictions 812.

The packaged recommendations comprising actionable guidance for failure prevention, maintenance scheduling, and production optimization flow to system output interfaces where human operators may review proposed actions and automated control systems may implement approved adjustments, with manifold journaling maintaining reversible mappings that trace each recommendation through simulation outputs, trajectory forecasts, Bayesian fusion distributions, and source telemetry and context inputs 813. The process supports risk-informed operational decision-making by translating complex predictive trajectories and latent uncertainty distributions into machine-generated actions aligned with ESP behavior, operational flexibility, and field-wide production goals 814.

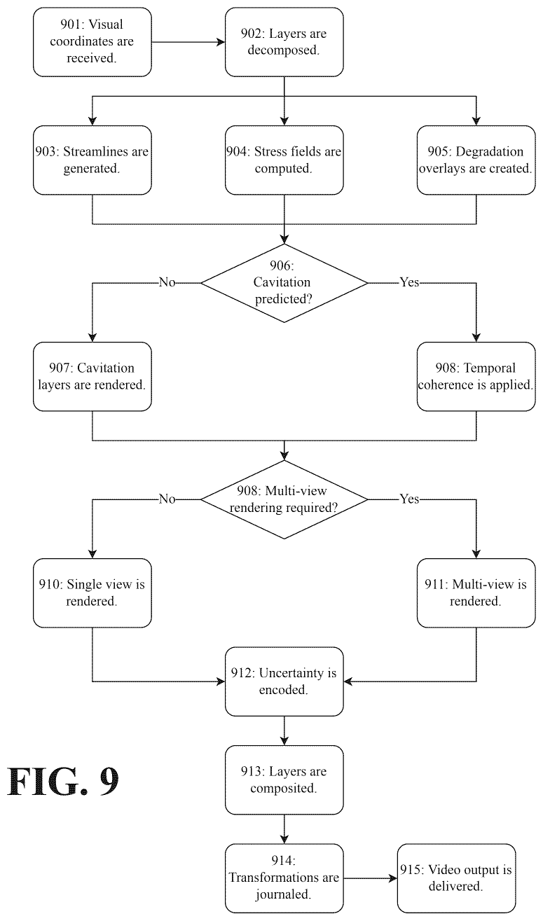

FIG. 9 is a flow diagram illustrating an exemplary multi-layer visualization synthesis process that generates temporally coherent synthetic video showing simultaneous representation of fluid flow, mechanical stress, and degradation progression, in an embodiment. The process begins when an ESP predictive video synthesis cortex 140 receives visual manifold coordinates with temporal evolution data from an ESP-specific projection operator library 135, where the coordinates represent transformed latent trajectory predictions produced by an ESP Bayesian fusion and uncertainty quantification system 130 based on prior telemetry and contextual data 901. The received visual coordinates flow to a decomposition operation that separates the unified coordinate representation into distinct visualization layer specifications including flow streamline coordinates, mechanical stress field coordinates, and degradation probability overlays, each reflecting structured data extracted from the latent manifold 902. The decomposed layer specifications proceed along parallel processing paths where a flow streamline generation operation computes vector fields through pump internals, traces fluid motion paths through impeller stages, and constructs dynamic geometries that evolve across the forecast horizon 903.

Concurrently, a stress distribution generation operation calculates stress tensor fields on impeller and shaft surfaces based on centrifugal forces and hydraulic loading, determines shaft stress from mechanical loads, and computes bearing contact stresses arising from transmitted force vectors 904. In parallel, a degradation overlay generation operation maps probability densities onto spatial regions of predicted wear, identifies localized erosion from entrained particles, and delineates scale deposition or corrosion zones based on fluid chemistry and flow conditions 905. The three visualization layers proceed to a cavitation detection operation that evaluates whether cavitation is predicted during the forecast period by comparing pressure field coordinates against vapor pressure thresholds and identifying low-pressure regions at risk of vapor bubble formation 906.

When cavitation is predicted, the process proceeds to a cavitation visualization addition operation that renders nucleation regions, depicts collapse zones with bubble implosion behavior, and illustrates cavitation extent and evolution through animated overlays anchored in physical coordinates 907. When cavitation is not predicted, the process bypasses this addition and continues with the remaining layers unmodified. Both paths converge at a temporal coherence application operation that enforces frame-to-frame continuity, aligns time-indexed layer transitions, maintains causal ordering of degradation sequences, and applies machine-executed smoothing filters to remove temporal discontinuities in the synthetic video 908.

The temporally coherent visualization data flows to a view mode decision operation that evaluates whether single or multi-view rendering is required based on user configuration, system defaults, or visualization complexity criteria 909. When single view rendering is selected, the process proceeds to a primary view generation operation that constructs a cutaway visualization showing internal flow, stress, degradation, and cavitation overlays from a unified perspective within a common spatial frame 910. When multi-view rendering is selected, the process proceeds to a multiple view generation operation that renders cutaway views, cross-sectional slices, and external boundary views, maintaining time-synchronized evolution across all views and aligning spatial transformations using shared geometric models 911.

Both output paths converge at an uncertainty encoding application operation that modulates layer opacity based on prediction variance, overlays confidence boundaries indicating statistically reliable regions, and inserts scenario branching visualizations where forecast trajectories diverge significantly across the prediction horizon 912. The uncertainty-encoded visualization layers flow to a compositing operation that assembles all layer types—flow, stress, degradation, cavitation, and uncertainty—into a unified video output, applying alpha blending, depth-aware occlusion ordering, and spatial alignment to produce a temporally consistent, interpretable forecast sequence 913. The composited video output proceeds to a journaling operation that records reversible mappings linking each rendered frame to its visual manifold coordinates, underlying latent predictions, Bayesian posterior distributions, and originating telemetry and contextual knowledge, preserving traceability across the full predictive pipeline 914.

The resulting multi-layer video output comprising temporally coherent representations of internal flow, mechanical stress evolution, degradation overlays, and uncertainty modulation is delivered to operator interfaces and decision support systems, enabling visual interpretation of anticipated pump behavior and supporting proactive intervention decisions based on interpretable renderings of predicted down-hole conditions 915.

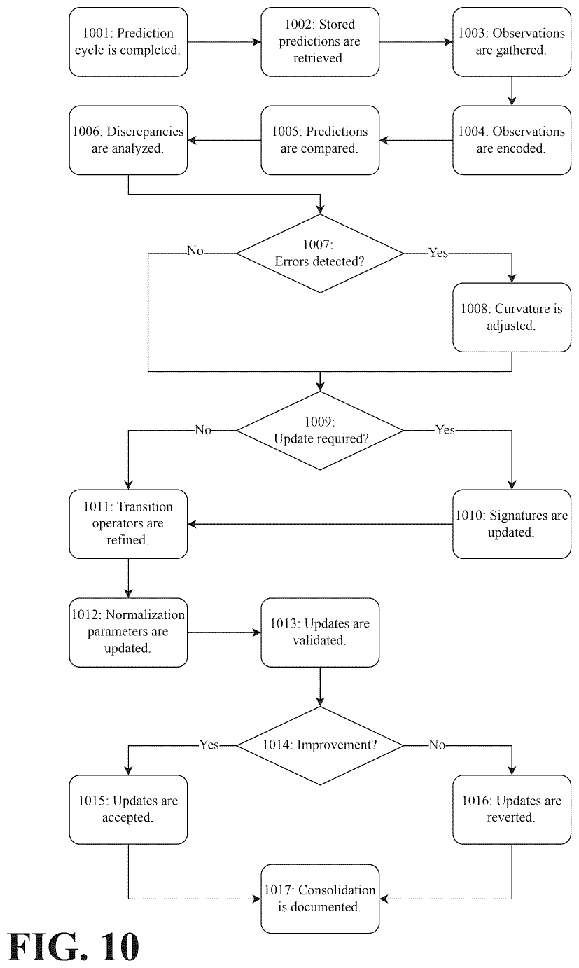

FIG. 10 is a flow diagram illustrating an exemplary sleep-state consolidation and manifold optimization process that compares predicted trajectories against subsequently observed operational outcomes to refine predictive model parameters, in an embodiment. The process begins after a prediction cycle has completed and sufficient time has elapsed to observe actual pump behavior corresponding to the prediction horizon, enabling retrospective evaluation of forecast accuracy 1001. The consolidation process initiates with a collection operation that retrieves stored prediction records from manifold journaling archives including prediction timestamps, latent positions, trajectory paths, and associated uncertainty bounds computed by the ESP Bayesian fusion and uncertainty quantification system 130 1002. The retrieved prediction records flow to an observation gathering operation that acquires actual telemetry data from the ESP telemetry acquisition and conditioning system 105 covering the forecast interval, including vibration, pressure, flow, temperature, motor current, and acoustic emissions 1003.

The observed telemetry data proceeds to an encoding operation performed by the ESP-specific tensor encoding system 115 that transforms the actual measurements into latent manifold coordinates using the same encoding procedures applied during the original prediction, generating representations directly comparable to the stored predicted states 1004. The encoded observed states and predicted states flow to a comparison operation that computes geodesic distance errors within the latent manifold, quantifies prediction discrepancies, and characterizes directional bias by evaluating consistent over- or under-estimation trends 1005. The computed errors proceed to an analysis operation that identifies regions exhibiting consistent discrepancies across multiple cycles, detects failure mode mismatches, and characterizes spatial and temporal prediction biases to guide targeted refinement 1006.

The discrepancy analysis results flow to a decision operation that evaluates whether systematic errors are present by analyzing bias consistency and error localization within the manifold structure 1007. When the decision operation determines that systematic errors are present, the process proceeds to a curvature adjustment operation that modifies curvature penalty parameters, updates metric tensor components, and refines the manifold geometry to better model observed pump behavior 1008. When systematic errors are not detected, the process bypasses curvature adjustment and continues to subsequent refinement steps.

Both paths converge at a decision operation that evaluates whether failure mode signatures in the historical library maintained by the ESP-focused predictive rollout system 125 require updating based on newly observed degradation patterns 1009. When the decision operation determines that observed failure trajectories exhibit characteristics not well represented in existing signatures, the process proceeds to a signature update operation that incorporates those trajectories into the historical failure signature library, augmenting pattern sets for gas locking, sand erosion, scale deposition, and bearing degradation 1010.

Both signature update paths converge at a transition operator refinement operation that adjusts temporal evolution operators governing latent state progression, modifies stochastic perturbation kernel parameters, and updates geodesic forecasting coefficients used by system 125 to improve trajectory prediction fidelity 1011. The refined operators flow to a normalization parameter update operation that adjusts affinity transformation coefficients, viscosity correction factors, and scaling parameters that support experience transfer and cross-well correlation consistency via system 145 1012. The updated geometry, operators, signatures, and normalization parameters proceed to a validation operation that tests predictive accuracy against held-out forecast scenarios not used during refinement, comparing pre- and post-update error metrics, failure identification rates, and uncertainty calibration 1013.

The validation results flow to a decision operation that evaluates whether prediction performance has improved by comparing error magnitudes, model fit, and calibration of confidence intervals over the validation set 1014. When the decision operation determines that performance has improved, the process proceeds to an acceptance operation that commits the refined parameters to the production configuration, making them available to downstream systems including the projection operator library 135 and predictive video synthesis cortex 140 for use in subsequent forecasting cycles 1015. When performance has not improved, the process proceeds to a reversion operation that restores the prior parameter configuration, preserves the previous manifold geometry, and records flagged discrepancies for further analysis in future consolidation cycles 1016.

The acceptance and reversion paths converge at a documentation operation that records prediction performance metrics before and after refinement, tracks changes to model parameters including curvature penalties, transition logic, normalization coefficients, and failure signatures, and logs insights regarding pump behavior, modeling assumptions, or anomalous degradation patterns uncovered during the consolidation process 1017.

### Exemplary Computing Environment

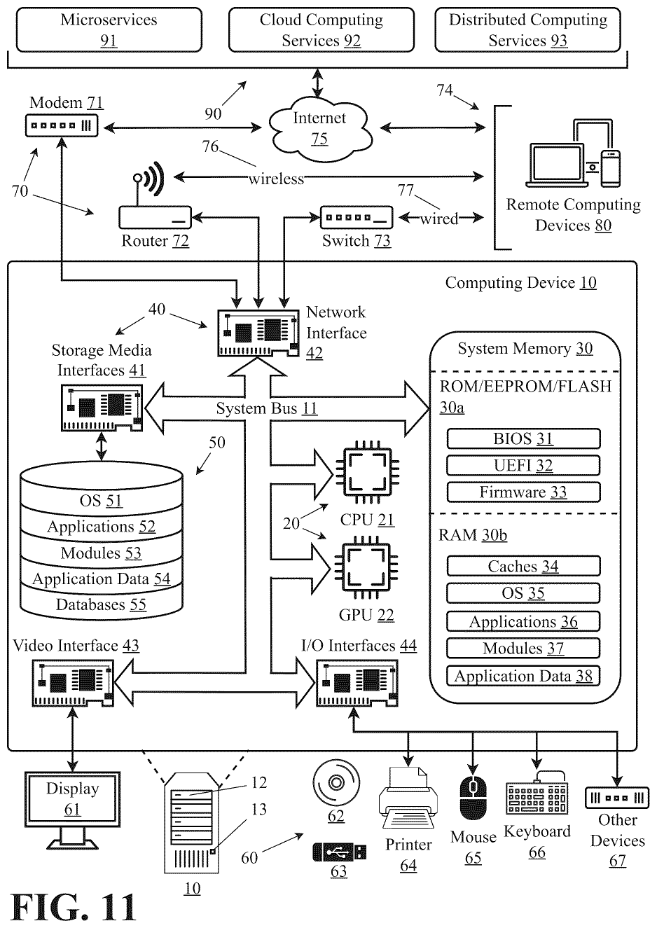

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance. There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system for generating predictive visual representations of electric submersible pump behavior from distributed sensor networks, the system comprising a hardware memory, wherein the computer system is configured to execute software instructions stored on nontransitory machine-readable storage media that:
maintain a persistent cognitive substrate incorporating a latent manifold with geometric representations of pump operating states across multiple pump installations;
receive telemetry data from a plurality of sensing modalities monitoring at least one electric submersible pump system, wherein the telemetry data comprises at least two of vibration, acoustic, flow, pressure, thermal, motor current, or rotational measurements;
encode the telemetry data into tensor-preserving latent representations within the latent manifold while maintaining pump physics relationships and temporal correlations;
correlate the encoded telemetry data with historical operational patterns from a plurality of pump installations by computing similarity metrics within the latent manifold;
compute predictive trajectories through the latent manifold by applying at least one of geodesic forecasting operators, stochastic perturbation kernels, or cross-installation pattern matching, wherein the predictive trajectories represent anticipated evolution of pump operational states;
apply domain-specific projection operators that transform the predictive trajectories into visual manifold coordinates representing at least one of pump internal conditions, fluid flow patterns, or degradation states;
generate synthetic visual output representing predicted future states of the pump system by decoding the visual manifold coordinates; and
provide operational recommendations based on the correlation between current pump trajectories and historical outcomes from the plurality of pump installations.

2. The computer system of claim 1, wherein the correlation with historical operational patterns comprises identifying pump installations with similar fluid compositions, operating depths, and pump configurations, and wherein the similarity metrics incorporate geodesic distances within the latent manifold weighted by fluid property correspondence and mechanical similarity factors.

3. The computer system of claim 1, wherein the domain-specific projection operators comprise a cavitation visualization operator that maps pressure field tensors to bubble volume fraction distributions based on local pressure differentials relative to vapor pressure, and wherein the synthetic visual output depicts bubble nucleation and collapse regions within pump impeller passages.

4. The computer system of claim 1, wherein the system further maintains a failure mode signature library encoding characteristic trajectory patterns for gas locking, sand erosion, scale deposition, and bearing degradation, and wherein computing predictive trajectories comprises calculating similarity scores between current latent manifold positions and the failure mode signatures to estimate time-to-failure distributions.

5. The computer system of claim 1, wherein the operational recommendations comprise adjustments to pump rotational speed, fluid injection rates, or choke positions to maintain the pump operating trajectory within a stable region of the latent manifold bounded by gas lock onset boundaries, cavitation thresholds, and mechanical resonance zones.

6. The computer system of claim 1, wherein the system implements federated prediction across geographically distributed oil fields, enabling pump installations to exchange predictive trajectories anchored by canonical ESP performance landmarks while maintaining local computational control over proprietary operational data.

7. The computer system of claim 1, wherein encoding the telemetry data comprises applying hydraulic affinity transformations that normalize pump performance curves across different rotational speeds and fluid viscosities, enabling the latent manifold to represent pump behavior independent of transient operating conditions.

8. The computer system of claim 1, wherein the synthetic visual output comprises a multi-layer rendering showing simultaneous visualization of fluid flow streamlines through pump stages, mechanical stress distributions on impeller surfaces, and probability density overlays indicating regions of predicted degradation, with temporal evolution spanning from current state through a configurable prediction horizon.

9. The computer system of claim 1, wherein the system performs sleep-state consolidation by comparing predicted pump trajectories against subsequently observed operational outcomes across the plurality of pump installations, and adjusts manifold curvature penalties in regions corresponding to specific failure modes to improve future prediction accuracy for similar pump configurations and operating conditions.

10. A computer-implemented method for generating predictive visual representations of electric submersible pump behavior from distributed sensor networks, the method comprising:
maintaining a persistent cognitive substrate incorporating a latent manifold with geometric representations of pump operating states across multiple pump installations;
receiving telemetry data from a plurality of sensing modalities monitoring at least one electric submersible pump system, wherein the telemetry data comprises at least two of vibration, acoustic, flow, pressure, thermal, motor current, or rotational measurements;
encoding the telemetry data into tensor-preserving latent representations within the latent manifold while maintaining pump physics relationships and temporal correlations;
correlating the encoded telemetry data with historical operational patterns from a plurality of pump installations by computing similarity metrics within the latent manifold;
computing predictive trajectories through the latent manifold by applying at least one of geodesic forecasting operators, stochastic perturbation kernels, or cross-installation pattern matching, wherein the predictive trajectories represent anticipated evolution of pump operational states;
applying domain-specific projection operators that transform the predictive trajectories into visual manifold coordinates representing at least one of pump internal conditions, fluid flow patterns, or degradation states;
generating synthetic visual output representing predicted future states of the pump system by decoding the visual manifold coordinates; and
providing operational recommendations based on the correlation between current pump trajectories and historical outcomes from the plurality of pump installations.

11. The method of claim 10, wherein correlating with historical operational patterns comprises identifying pump installations with similar fluid compositions, operating depths, and pump configurations, and wherein the similarity metrics incorporate geodesic distances within the latent manifold weighted by fluid property correspondence and mechanical similarity factors.

12. The method of claim 10, wherein applying domain-specific projection operators comprises applying a cavitation visualization operator that maps pressure field tensors to bubble volume fraction distributions based on local pressure differentials relative to vapor pressure, and wherein the synthetic visual output depicts bubble nucleation and collapse regions within pump impeller passages.

13. The method of claim 10, further comprising maintaining a failure mode signature library encoding characteristic trajectory patterns for gas locking, sand erosion, scale deposition, and bearing degradation, and wherein computing predictive trajectories comprises calculating similarity scores between current latent manifold positions and the failure mode signatures to estimate time-to-failure distributions.

14. The method of claim 10, wherein providing operational recommendations comprises determining adjustments to pump rotational speed, fluid injection rates, or choke positions to maintain the pump operating trajectory within a stable region of the latent manifold bounded by gas lock onset boundaries, cavitation thresholds, and mechanical resonance zones.

15. The method of claim 10, further comprising implementing federated prediction across geographically distributed oil fields, enabling pump installations to exchange predictive trajectories anchored by canonical ESP performance landmarks while maintaining local computational control over proprietary operational data.

16. The method of claim 10, wherein encoding the telemetry data comprises applying hydraulic affinity transformations that normalize pump performance curves across different rotational speeds and fluid viscosities, enabling the latent manifold to represent pump behavior independent of transient operating conditions.

17. The method of claim 10, wherein generating synthetic visual output comprises producing a multi-layer rendering showing simultaneous visualization of fluid flow streamlines through pump stages, mechanical stress distributions on impeller surfaces, and probability density overlays indicating regions of predicted degradation, with temporal evolution spanning from current state through a configurable prediction horizon.

18. The method of claim 10, further comprising performing sleep-state consolidation by comparing predicted pump trajectories against subsequently observed operational outcomes across the plurality of pump installations, and adjusting manifold curvature penalties in regions corresponding to specific failure modes to improve future prediction accuracy for similar pump configurations and operating conditions.
